(19) United States
(12) Patent Application Publication
(10) Pub. No.: US 2026/0052529 A1
(43) Pub. Date: Feb. 19, 2026

(54) SYSTEMS AND METHODS FOR THE SUPPORT OF MULTIPLE TRANSMIT UPLINK TRANSMISSIONS

(71) Applicant: APPLE INC., Cupertino, CA (US)

(72) Inventors: Sigen Ye, San Diego, CA (US); Wei Zeng, San Diego, CA (US); Seyed Ali Akbar Fakoorian, San Diego, CA (US); Weidong Yang, San Diego, CA (US); Hong He, San Jose, CA (US); Dawei Zhang, Saratoga, CA (US); Haitong Sun, Cupertino, CA (US)

(21) Appl. No.: 19/102,205

(22) PCT Filed: Jul. 14, 2023
(86) PCT No.: PCT/US2023/070258

§ 371 Date: Feb. 7, 2025

Related U.S. Application Data
(60) Provisional application No. 63/371,209, filed on Aug. 11, 2022.

(51) Int. Cl. H04W 72/1268; H04B 7/0456; H04W 72/232

(52) U.S. Cl. CPC H04W 72/1268; H04B 7/0456; H04W 72/232

(57) ABSTRACT

Systems and methods for supporting multiple (e.g., eight) transmit (Tx) uplink (UL) transmissions are discussed. This includes discussion of related codebook-based transmission schemes. User equipment (UE) capabilities and configurations are discussed. Detailed codebook design for a full-coherent eight Tx UL is discussed. Associated rank indicator (RI) and transmit precoding matrix indicator (TPMI) indexes in downlink control information (DCI), including various enhancements for overhead reduction, are also discussed. In some embodiments, a UE receives, from a network, a DCI that schedules an UL transmission and includes a precoder index to a first precoder of a fully-coherent codebook corresponding to an antenna configuration supported by the UE having a plurality of precoders for a use of eight fully-coherent antenna ports; identifies the first precoder from the plurality of precoders using the precoder index; precodes the UL transmission using the first precoder; and transmits the precoded UL transmission to the network.

### CROSS-REFERENCE TO RELATED APPLICATION

This application claims priority to U.S. Provisional Patent Application No. 63/371,209 filed Aug. 11, 2022 and entitled “SYSTEMS AND METHODS FOR THE SUPPORT OF MULTIPLE TX UPLINK TRANSMISSIONS,” the entire disclosure of which is hereby incorporated by reference.

### TECHNICAL FIELD

This application relates generally to wireless communication systems, including wireless communication systems using codebook-based transmission schemes.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a table detailing the use of a MIMO UL two Tx codebook (including the use of a related TPMI) in cases of the use of two APs, the use of CP-OFDM, and a maximum rank equal to two (maxRank=2).

FIG. 2 illustrates a table detailing the use of a MIMO UL two Tx codebook (including the use of a related TPMI) in cases of the use two APs, the use of CP-OFDM, and a maximum rank equal to one (maxRank=1).

FIG. 3 illustrates a table for a precoding matrix W for single layer-transmission using two APs.

FIG. 4 illustrates a table for a precoding matrix W for two-layer transmission using two APs with transform precoding disabled.

FIG. 5 illustrates a table detailing the use of a MIMO UL four Tx codebook (including the use of a related TPMI) in cases of the use of four APs, the use CP-OFDM, and a maximum rank equal to two, three, or four (maxRank=2/3/4).

FIG. 6 illustrates a table detailing the use of a MIMO UL four Tx codebook (including the use of a related TPMI) in cases of the use of four APs, the use of CP-OFDM, and a maximum rank equal to one (maxRank=1).

FIG. 7 illustrates a table for a precoding matrix W for single-layer transmission using four APs with transform precoding disabled.

FIG. 8 illustrates a table for a precoding matrix W for two-layer transmission using four APs with transform precoding disabled.

FIG. 9 illustrates a table for a precoding matrix W for three-layer transmission using four APs with transform precoding disabled.

FIG. 10 illustrates a table for a precoding matrix W for four-layer transmission using four APs with transform precoding disabled.

FIG. 11 illustrates a table of supported configurations of (N₁,N₂) and (O₁,O₂), for various codebooks for MIMO DL operation through an antenna panel of a base station, according to embodiments.

FIG. 12 illustrates a table of a codebook for one layer CSI reporting using APs 3000 to 2999+P_{CSI-RS}.

FIG. 13 illustrates a table of a codebook for two layer CSI reporting using APs 3000 to 2999+P_{CSI-RS}.

FIG. 14 illustrates a table showing a mapping of i_{1,3} to k₁ and k₂ for the two layer CSI reporting case.

FIG. 15 illustrates a table of a codebook for three layer CSI reporting using APs 3000 to 2999+P_{CSI-RS}

FIG. 16 illustrates a table of a codebook for four layer CSI reporting using APs 3000 to 2999+P_{CSI-RS}.

FIG. 17 illustrates a table showing a mapping of i_{1,3} to k₁ and k₂ for the three layer CSI reporting and the four layer CSI reporting cases when P_{CSI-RS}<16.

FIG. 18 illustrates a table showing antenna layouts that may be used with fully-coherent antenna configurations and/or codebooks, according to various embodiments.

FIG. 19 illustrates a table showing the number of bits used for PMI information for each rank value in the case where a codebook mode 1 of DL eight Tx Type-1 single-panel codebook design is directly reused (and with the same oversampling factor rules used).

FIG. 20 illustrates a table showing a corresponding bit width for these ranks and antenna layout conditions for cases where there is no oversampling and O₁=O₂=1.

FIG. 21 illustrates a table showing calculations for beam index offset values k₁ and k₂ for various antenna layouts in cases where a one bit i_{1,3} may be used.

FIG. 22 illustrates a table showing pre-defined beam index offset values k₁ and k₂ for various antenna layouts in cases where a zero bit i_{1,3} may be used.

FIG. 23 illustrates a table showing a corresponding bit width for cases where PMI for rank 7 and/or 8 is modified for increased granularity.

FIG. 24 illustrates a table showing a corresponding bit width for cases where different oversampling factors for different rank values are selected.

FIG. 25 illustrates a table that may be defined, where the table shows a corresponding bit width in the case where N₁=N₂=2.

As another example, FIG. 26 illustrates a table that may be defined, where the table shows a corresponding bit width in the case where N₁=4 and N₂=1.

FIG. 27 illustrates a table that may be defined, where the table shows a corresponding bit width in the case where N₁=N₂=2.

FIG. 28 illustrates a method of a UE, according to embodiments discussed herein.

FIG. 29 illustrates method of a RAN, according to embodiments discussed herein

FIG. 30 illustrates a method of a UE, according to embodiments discussed herein.

FIG. 31 illustrates a method of a RAN, according to embodiments discussed herein.

FIG. 32 illustrates an example architecture of a wireless communication system, according to embodiments disclosed herein.

FIG. 33 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

It may be beneficial to define a specification for uplink (UL) demodulation reference signal (DMRS), sounding reference signal (SRS), scheduling request indicator (SRI), and/or transmit precoding matrix indicator (TPMI) (including codebook) enhancements to enable eight transmit (Tx) UL operation, where the UE may use (up to) eight antenna ports (APs) corresponding to these operations. In some embodiments, this may enable the support of the use of up to eight layers per UE in UL.

Use cases for such operation may be targeted to the use of, for example, customer premises equipment (CPE), fixed wireless access (FWA), vehicle, and/or industrial devices. Note that these use cases are given by way of example and not by way of limitation.

Such a specification may potentially operate with respect to a particular scope (e.g., as related to coherence assumption, full/non-full power mode assumptions, etc.) in some embodiments.

Embodiments herein discuss aspects of codebook design for eight Tx cases and mechanisms for precoder indication(s) corresponding to such a codebook.

Various alternatives for the consideration of eight Tx UE codebook-based uplink transmission include: the use of UL two Tx/four Tx codebooks and/or 8×1 antenna selection vector(s) as the starting point for the design of a codebook for non-coherent UEs and the use of a downlink (DL) Type I codebook as the starting point for the design of a codebook for fully/partially-coherent UEs; the use of UL two Tx/four Tx codebooks and/or 8×1 antenna selection vector(s) as the starting point for design of a codebook for partially/non-coherent UEs and the use of a DL Type I codebook as the starting point for the design of a codebook for fully-coherent UEs; the use of UL two Tx/four Tx codebooks and/or 8×1 antenna selection vector(s) as the starting point for design of a codebook for fully/partially/non-coherent UEs; the use of UL two Tx/four Tx codebooks and/or 8×1 antenna selection vector(s) in combination with those based on DL Type I codebooks as a starting point for the design of a codebook for fully/partially/non-coherent UEs; and a DL Type I codebook as the starting point for the design of a codebook for fully/partially/non-coherent UEs.

Further, transmission using one or multiple precoders corresponding to one or multiple SRS resources may be considered in the context of the above alternatives.

### MIMO UL Two Tx Codebook and TPMI

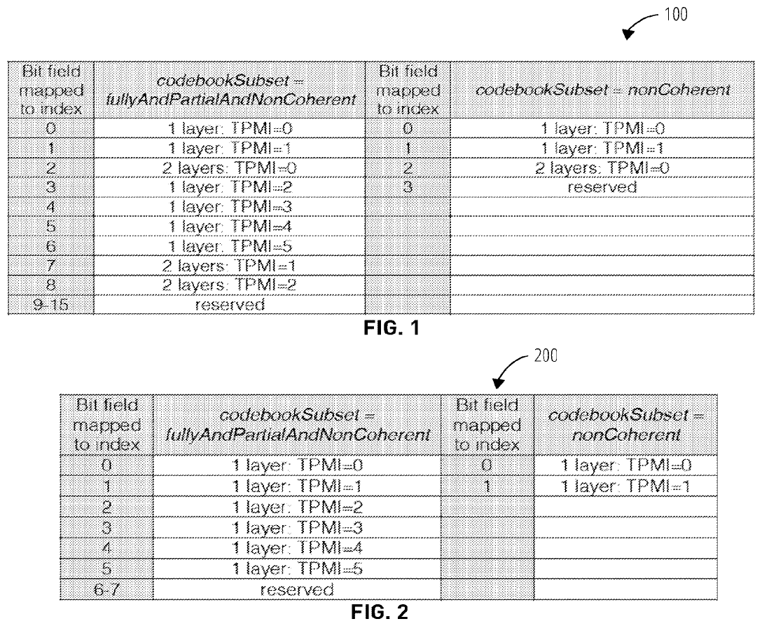

FIG. 1 illustrates a table 100 detailing the use of a MIMO UL two Tx codebook (including the use of a related TPMI) in cases of the use of two APs, the use of cyclic-prefix orthogonal frequency division multiplexing (CP-OFDM), and a maximum rank equal to two (maxRank=2). The table 100 is for precoding information and number of layers for two APs in the case that a transform precoder is disabled and maxRank=2. See, e.g., 3GPP Technical Specification (TS) 38.212 v. 17.2.0 (June 2022) (hereinafter “TS 38.212”), Table 7.3.1.1.2-4.

As may be seen, the entries in the table 100 are subdivided into a first set of entries that is used by the UE when the network indicates to the UE to use a codebook having fully-coherent, partially-coherent, and non-coherent precoders and a second set of entries that is used by the UE when the network indicates to the UE to use a codebook having (only) non-coherent precoders. Then, with respect to the applicable coherency case, each of the entries in the table 100 maps a bit field that may be received in a downlink control information (DCI) to a number of transmission layers that the UE is to use for a corresponding UL transmission and a TPMI index to be used to determine a precoder for the UL transmission.

FIG. 2 illustrates a table 200 detailing the use of a MIMO UL two Tx codebook (including the use of a related TPMI) in cases of the use two APs, the use of CP-OFDM, and a maximum rank equal to one (maxRank=1). The table 200 is for precoding information and number of layers for two APs in the case that a transform precoder is enabled, or in the case that the transform precoder is disabled and maxRank=1. See, e.g., TS 38.212, Table 7.3.1.1.2-5.

As may be seen, the entries in the table 200 are subdivided into a first set of entries that is used by the UE when the network indicates to the UE to use a codebook having fully-coherent, partially-coherent, and non-coherent precoders and a second set of entries that is used by the UE when the network indicates to the UE to use a codebook having (only) non-coherent precoders. Then, with respect to the applicable coherency case, each of the entries in the table 200 maps a bit field that may be received in a downlink control information (DCI) to a number of transmission layers that the UE is to use for a corresponding UL transmission and a TPMI index to be used to determine a precoder for the UL transmission.

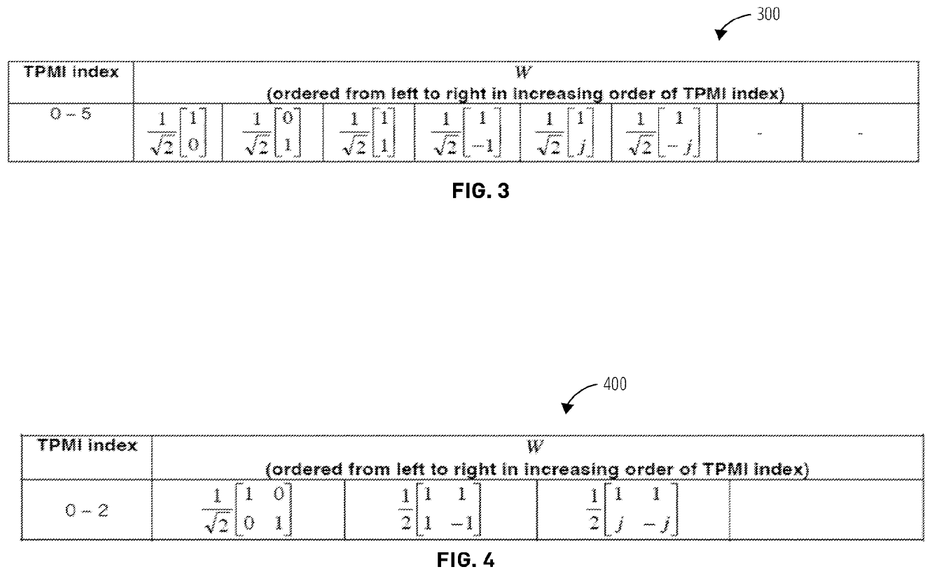

FIG. 3 illustrates a table 300 for a precoding matrix W for single layer-transmission using two APs. See, e.g., 3GPP TS 38.211 v. 17.2.0 (June 2022) (hereinafter “TS 38.211”), Table 6.3.1.5-1.

The table 300 may be used with a TPMI index determined according to the mechanism for an UL transmission that is described in relation to the table 100 or the table 200 to identify a precoder for the UL transmission in cases of a single layer transmission using two APs.

FIG. 4 illustrates a table 400 for a precoding matrix W for two-layer transmission using two APs with transform precoding disabled. See, e.g., TS 38.211, Table 6.3.1.5-4.

The table 400 may be used with a TPMI index determined according to the mechanism for an UL transmission that is described in relation to the table 100 to identify a precoder for the UL transmission in cases of a two layer transmission using two APs.

### Embodiments of MIMO UL Four Tx Codebook and TPMI

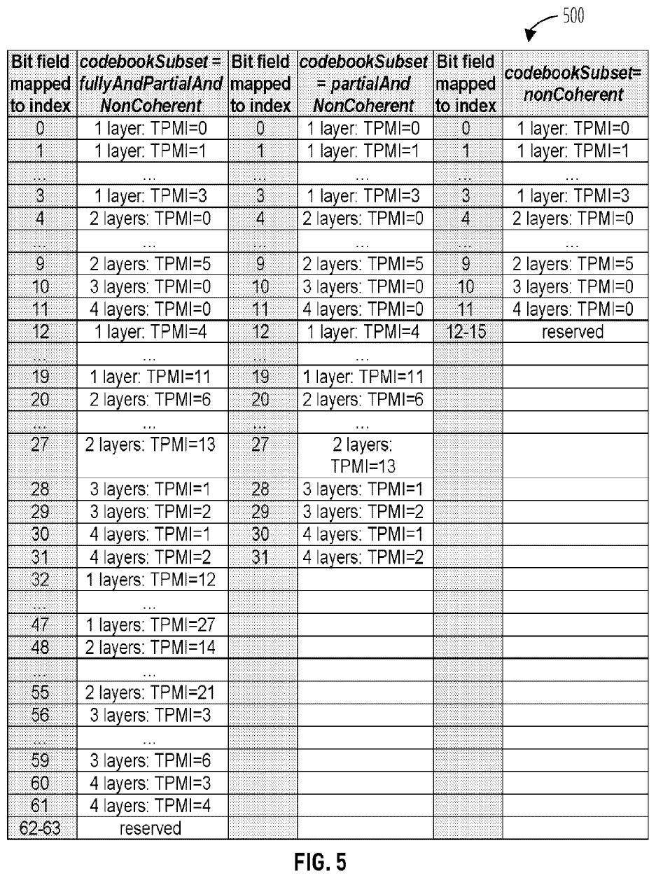

FIG. 5 illustrates a table 500 detailing the use of a MIMO UL four Tx codebook (including the use of a related TPMI) in cases of the use of four APs, the use CP-OFDM, and a maximum rank equal to two, three, or four (maxRank=2/3/4). The table 500 is for precoding information and number of layers for four APs in the case that a transform precoder is disabled and maxRank=2/3/4. See, e.g., TS 38.212, Table 7.3.1.1.2-2.

As may be seen, the entries in the table 500 are subdivided into a first set of entries that is used by the UE when the network indicates to the UE to use a codebook having fully-coherent, partially-coherent, and non-coherent precoders, a second set of entries that is used by the UE when the network indicates to the UE to use a codebook having partially-coherent and non-coherent precoders (and not having fully-coherent precoders), and a third set of entries that is used by the UE when the network indicates to the UE to use a codebook having (only) non-coherent precoders. Then, with respect to the applicable coherency case, each of the entries in the table 500 maps a bit field that may be received in a DCI to a number of transmission layers that the UE is to use for a corresponding UL transmission and a TPMI index to be used to determine a precoder for the UL transmission.

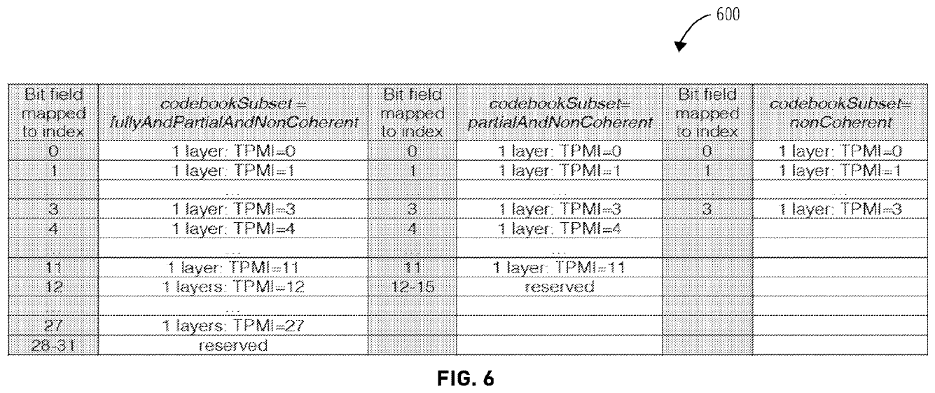

FIG. 6 illustrates a table 600 detailing the use of a MIMO UL four Tx codebook (including the use of a related TPMI) in cases of the use of four APs, the use of CP-OFDM, and a maximum rank equal to one (maxRank=1). The table 600 is for precoding information and number of layers for four APs in the case that a transform precoder is enabled or in the case that the transform precoder is disabled and maxRank=1. See, e.g., TS 38.212, Table 7.3.1.1.2-3.

As may be seen, the entries in the table 600 are subdivided into a first set of entries that is used by the UE when the network indicates to the UE to use a codebook having fully-coherent, partially-coherent, and non-coherent precoders, a second set of entries that is used by the UE when the network indicates to the UE to use a codebook having partially-coherent and non-coherent precoders (and not having fully-coherent precoders), and a third set of entries that is used by the UE when the network indicates to the UE to use a codebook having (only) non-coherent precoders. Then, with respect to the applicable coherency case, each of the entries in the table 600 maps a bit field that may be received in a DCI to a number of transmission layers that the UE is to use for a corresponding UL transmission and a TPMI index to be used to determine a precoder for the UL transmission.

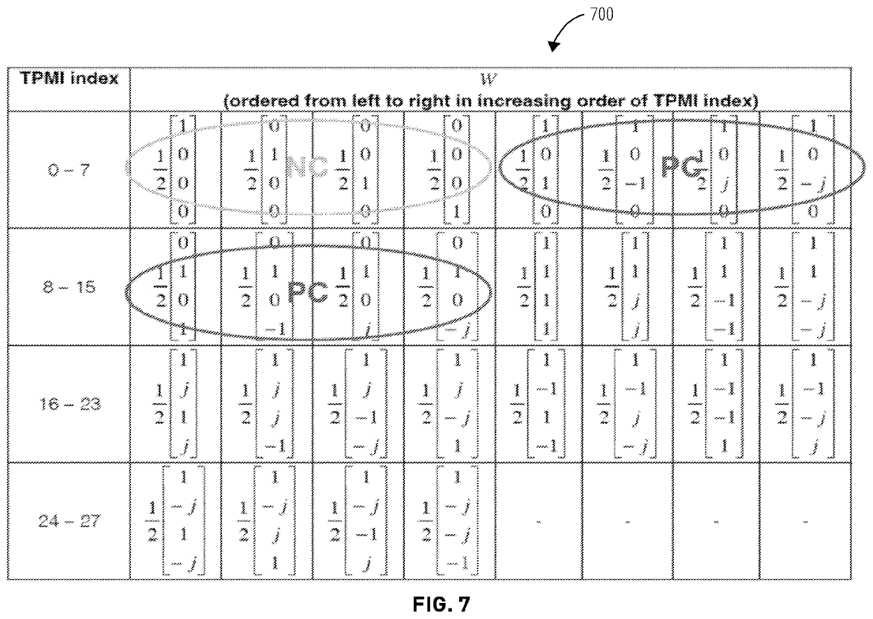

FIG. 7 illustrates a table 700 for a precoding matrix W for single-layer transmission using four APs with transform precoding disabled. See, e.g., TS 38.211, Table 6.3.1.5-3. The table 700 further corresponds to a case of the use of CP-OFDM.

The table 700 may be used with a TPMI index determined according to the mechanism for an UL transmission that is described in relation to the table 500 or the table 600 to identify a precoder for the UL transmission in cases of a single layer transmission using four APs.

In the table 700, non-coherent (“NC”) and partially-coherent (“PC”) precoders have been explicitly labelled (with the remaining unlabeled precoders being fully-coherent precoders).

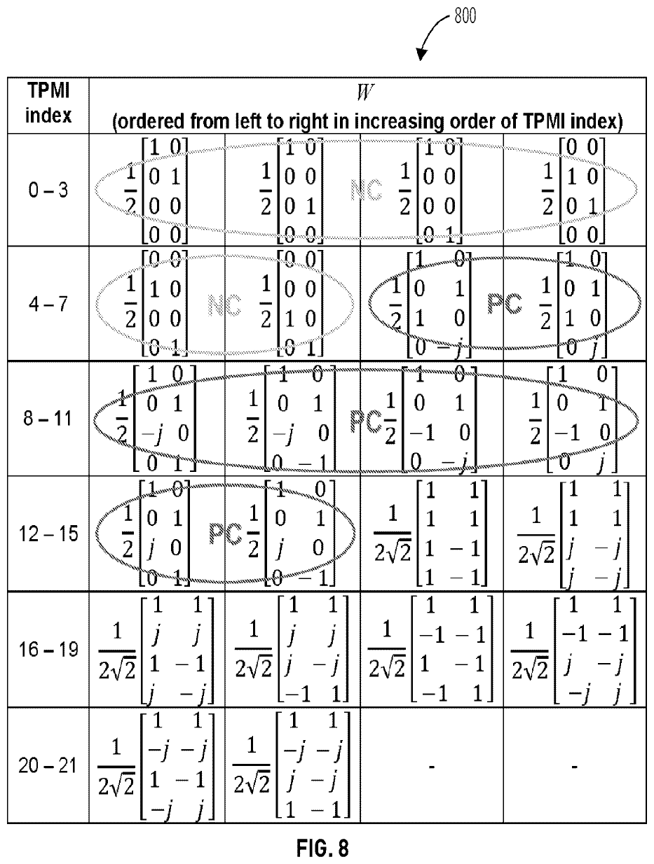

FIG. 8 illustrates a table 800 for a precoding matrix W for two-layer transmission using four APs with transform precoding disabled. See, e.g., TS 38.211, Table 6.3.1.5-5. The table 800 further corresponds to a case of the use of CP-OFDM.

The table 800 may be used with a TPMI index determined according to the mechanism for an UL transmission that is described in relation to the table 500 or the table 600 to identify a precoder for the UL transmission in cases of a two layer transmission using four APs.

In the table 800, non-coherent (“NC”) and partially-coherent (“PC”) precoders have been explicitly labelled (with the remaining unlabeled precoders being fully-coherent precoders).

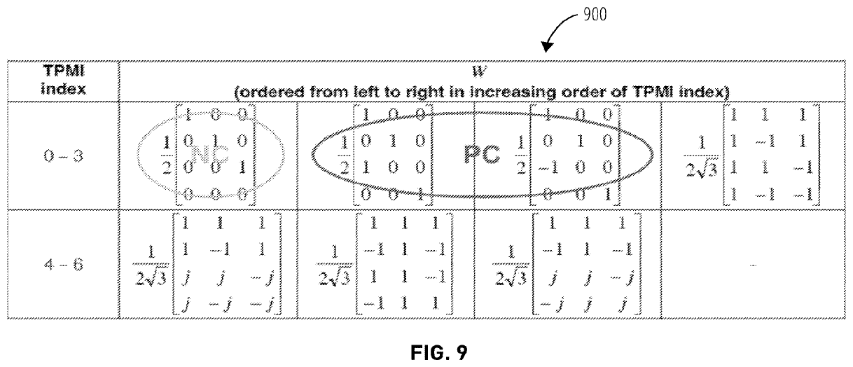

FIG. 9 illustrates a table 900 for a precoding matrix W for three-layer transmission using four APs with transform precoding disabled. See, e.g., TS 38.211, Table 6.3.1.5-6. The table 900 further corresponds to a case of the use of CP-OFDM.

The table 900 may be used with a TPMI index determined according to the mechanism for an UL transmission that is described in relation to the table 500 or the table 600 to identify a precoder for the UL transmission in cases of a three layer transmission using four APs.

In the table 900, non-coherent (“NC”) and partially-coherent (“PC”) precoders have been explicitly labelled (with the remaining unlabeled precoders being fully-coherent precoders).

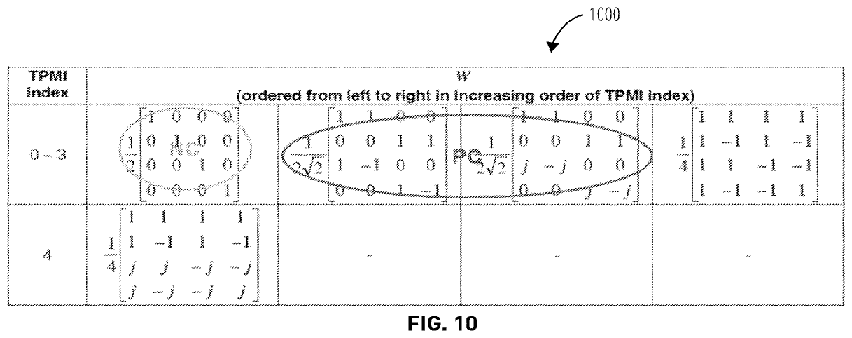

FIG. 10 illustrates a table 1000 for a precoding matrix W for four-layer transmission using four APs with transform precoding disabled. See, e.g., TS 38.211, Table 6.3.1.5-7. The table 1000 further corresponds to a case of the use of CP-OFDM.

The table 1000 may be used with a TPMI index determined according to the mechanism for an UL transmission that is described in relation to the table 500 or the table 600 to identify a precoder for the UL transmission in cases of a four layer transmission using four APs.

In the table 1000, non-coherent (“NC”) and partially-coherent (“PC”) precoders have been explicitly labelled (with the remaining unlabeled precoders being fully-coherent precoders).

### Embodiments of MIMO DL Eight Tx Codebook

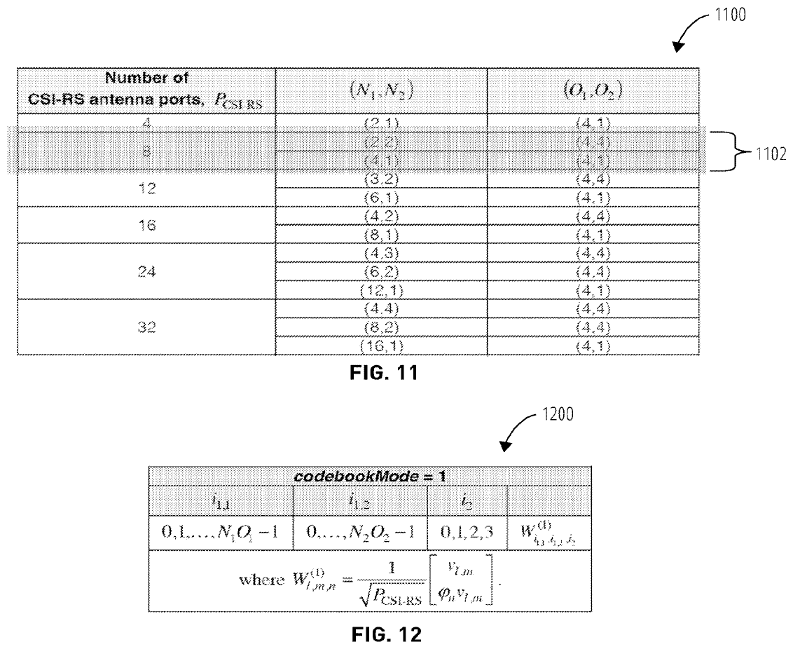

FIG. 11 illustrates a table 1100 of supported configurations of (N₁,N₂) and (O₁,O₂), for various codebooks for MIMO DL operation through an antenna panel of a base station, according to embodiments. See, e.g., 3GPP TS 38.214 v. 17.2.0 (June 2022) (hereinafter “TS 38.214”), Table 5.2.2.2.1-2. As used in, e.g., the table 1100, N₁ is a number of cross-polarized antenna elements of the antenna panel in a horizontal direction, N₂ is a number of cross-polarized antenna elements of the antenna panel in a vertical direction, O₁ is an oversampling factor used in the horizontal direction, and O₂ is an oversampling factor used in the vertical direction.

For MIMO DL 8 Tx codebook mode 1, the supported configurations for eight Tx with respect to values of (N₁,N₂) and (O₁,O₂) are represented by the entries 1102 in the table 1100. In such cases, it may be understood that two-dimensional (2-D) discrete Fourier transform (DFT)-based beams with an oversampling factor of up to four (consistent with the entries 1102) are used for codebook construction.

To communicate a DL eight Tx precoder to the base station for consideration by the base station, a UE uses a channel state information (CSI) reporting process that references a codebook that corresponds to a particular configuration of (N₁,N₂) at the base station and a number of layers to be used for the DL transmission. Examples of the construction of such codebooks follow.

FIG. 12 illustrates a table 1200 of a codebook for one layer CSI reporting using APs 3000 to 2999+P_{CSI-RS}. See, e.g., TS 38.214, 5.2.2.2.1-5. In the case of one layer CSI reporting, i_{1,1} and i_{1,2} are used to indicate a beam index in the 2-D dimension for a beam used by the antenna panel in terms of N₁ and N₂, while i₂ is used to determine the co-phasing coefficient between the two polarizations used at the antenna panel.

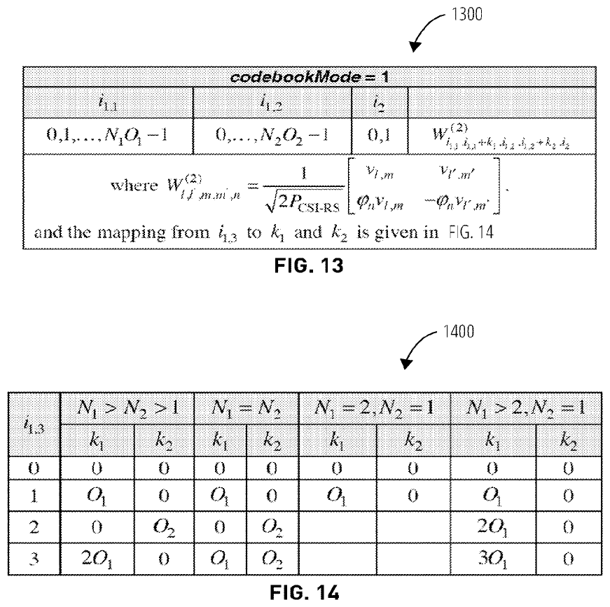

FIG. 13 illustrates a table 1300 of a codebook for two layer CSI reporting using APs 3000 to 2999+P_{CSI-RS}. See, e.g., TS 38.214, 5.2.2.2.1-6. In the case of two layer CSI reporting, i_{1,1} and i_{1,2} are used to indicate a beam index in the 2-D dimension for a first beam used by the antenna panel in terms of N₁ and N₂, i_{1,3} maps to values k₁ and k₂, which provide offset(s) from N₁ and N₂ for the position of a second beam used by the antenna panel relative to the first beam in terms of multiples of applicable oversampling factor(s) O₁ and/or O₂, and i₂ is used to determine a co-phasing coefficient between the two polarizations.

FIG. 14 illustrates a table 1400 showing a mapping of i_{1,3} to k₁ and k₂ for the two layer CSI reporting case. See, e.g., TS 38.214, 5.2.2.2.1-3. As may be seen, the entries in the table 1400 that define the use of k₁ and k₂ in terms of the applicable i_{1,3} value are subdivided into a first set of entries that is used by the UE when N₁>N₂>1, a second set of entries that is used by the UE when N₁=N₂, a third set of entries that is used by the UE when N₁=2 and N₂=1, and a fourth set of entries that is used by the UE when N₁>2 and N₂=1.

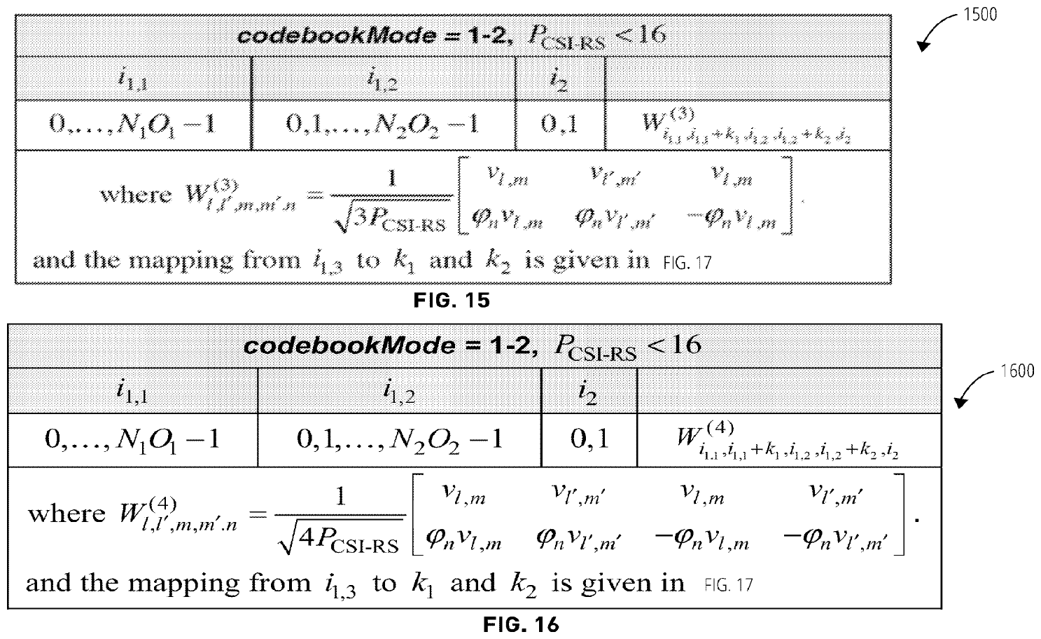

FIG. 15 illustrates a table 1500 of a codebook for three layer CSI reporting using APs 3000 to 2999+P_{CSI-RS}. See, e.g., TS 38.214, 5.2.2.2.1-7.

FIG. 16 illustrates a table 1600 of a codebook for four layer CSI reporting using APs 3000 to 2999+P_{CSI-RS}. See, e.g., TS 38.214, 5.2.2.2.1-8.

In the case of three layer or four layer CSI reporting, i_{1,1} and i_{1,2} are used to indicate a beam index in the 2-D dimension for a first beam used by the antenna panel in terms of N₁ and N₂, i_{1,3} maps to k₁ and k₂, which provide offset(s) from N₁ and N₂ for the position of a second beam used by the antenna panel relative to the first beam in terms of multiples of applicable oversampling factor(s) O₁ and/or O₂, and i₂ is used to determine a co-phasing coefficient between the two polarizations.

Then, in the case of three layer CSI reporting, two layers are transmitted on the first beam using two polarizations.

Further, in the case of four layer CSI reporting, two layers are transmitted on each of the first beam and the second beam using two polarizations.

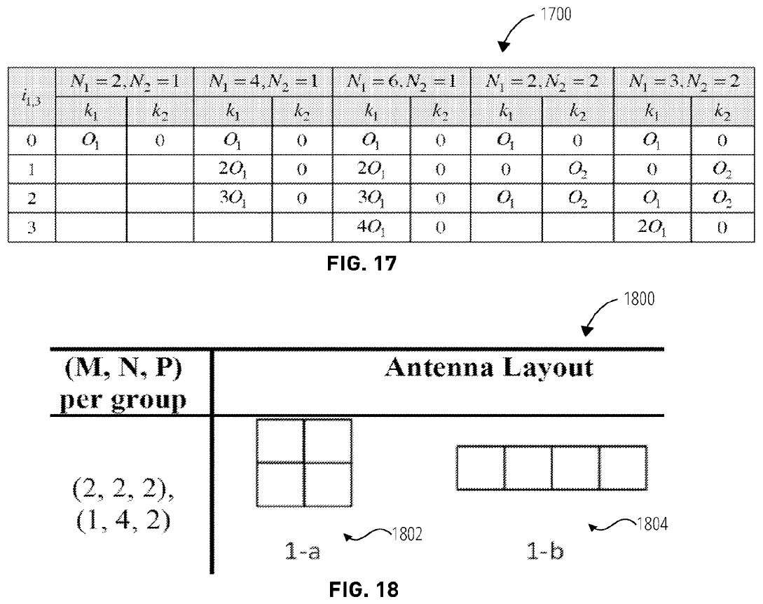

FIG. 17 illustrates a table 1700 showing a mapping of i_{1,3} to k₁ and k₂ for the three layer CSI reporting and the four layer CSI reporting cases when P_{CSI-RS}<16. See, e.g., TS 38.214, 5.2.2.2.1-4. As may be seen, the entries in the table 1700 that define the use of k₁ and k₂ in terms of the applicable i_{1,3} value are subdivided into a first set of entries that is used by the UE when N₁=2 and N₂=1, a second set of entries that is used by the UE when N₁=4 and N₂=1, a third set of entries that is used by the UE when N₁=6 and N₂=1, a fourth set of entries that is used by the UE when N₁=2 and N₂=2, and a fifth set of entries that is used by the UE when N₁=3 and N₂=2.

In cases of five layer CSI reporting and/or six layer CSI reporting, i_{1,1} and i_{1,2} values are used to indicate a beam index in the 2-D dimension for a first beam used by the antenna panel in terms of N₁ and N₂, second and third beams used by the antenna panel each have a pre-defined offset relative to the first beam, and a value i₂ is used to determine a co-phasing coefficient between the two polarizations.

Then, in the case of five layer CSI reporting, two layers are transmitted on each of the first and second beams using two polarizations.

Further, in case of six layer CSI reporting, two layers are transmitted on each of all three beams using two polarizations.

In cases of seven layer CSI reporting and/or eight layer CSI reporting, i_{1,1} and i_{1,2} values are used to indicate a beam index in the 2-D dimension for a first beam used by the antenna panel in terms of N₁ and N₂, second, third and fourth beams used by the antenna panel each have a pre-defined offset relative to the first beam, and a value i₂ is used to determine a co-phasing coefficient between the two polarizations.

Then, in the case of seven layer CSI reporting, two layers are transmitted on each of the first, second, and third beams using two polarizations.

Further, in case of eight layer CSI reporting, two layers are transmitted on each of all four beams using two polarizations.

### UE Capabilities and Configurations for Eight Tx UL Operation

Embodiments herein relate to various aspects of eight Tx UL transmissions, including codebook-based transmission schemes associated with such aspects. UE capabilities and configurations are discussed with respect to such cases. Further, detailed codebook design for a fully-coherent eight Tx UL transmission scheme is discussed. Once such a codebook is configured at a UE, the network may then provide the UE of an indication of which precoder to use from that codebook for the eight Tx UL transmission. Accordingly, associated rank and precoding matrix indicator (PMI) aspects in/for downlink control information (DCI), including various enhancements for overhead reduction, are also discussed.

A UE may report whether it supports eight Tx UL operation. In such cases, the UE may further report any/all of: one or more antenna configuration(s) that are supported at the UE, one or more codebook(s) that are supported by the UE (where each such codebook may be understood to correspond to one of the antenna configurations), a maximum number of layers (or maximum rank) supported by the UE, and/or value(s) for number(s) of layers that are supported by the UE.

Information related to antenna configuration(s) or the corresponding codebook(s) that may be reported to be supported by a UE are now discussed. The UE may report whether it supports fully-coherent, partially-coherent, and/or non-coherent antenna configurations (and/or whether it supports corresponding fully-coherent, partially-coherent, and/or non-coherent codebooks). It may be understood that these antenna configurations/codebooks correspond to antenna layouts that are supported for those antenna configurations/codebooks (and that information about such antenna layouts may therefore also be indicated by the UE report or otherwise understood with respect to the reported antenna configurations/codebooks). FIG. 18 illustrates a table 1800 showing antenna layouts that may be used with fully-coherent antenna configurations and/or codebooks, according to various embodiments. For a fully-coherent antenna configuration and/or codebook, typical antenna layouts may include (N₁, N₂, P) (where P is a number of polarizations used at the antenna panel) of (2, 2, 2) or (1, 4, 2) or (4, 1, 2). Accordingly, for example, the UE may report whether it supports (2, 2, 2) (as in, e.g., the antenna layout 1-a 1802 of FIG. 18), (1, 4, 2) (as in, e.g., the antenna layout 1-b 1804 of FIG. 18) or (4, 1, 2).

For a partially-coherent antenna configuration and/or codebook, the UE may report the number of antenna groups and the antenna layout within a group. There can be two or four antenna groups, and the APs within each antenna group may be coherent as within the group. Typical antenna layouts in such circumstances may include two groups of (1, 2, 2), and four groups of (1, 1, 2). The UE may report which layout(s) it supports.

Information related to a maximum number of layers (or maximum rank) supported by the UE for an UL transmission that may be reported by a UE is now discussed. Candidate values for the maximum number of layers reported in such cases could include, e.g., four, six, and eight.

Information related to supported values for the number of layers (or values for supported ranks) that may be reported by a UE is now discussed. For a UE supporting up to eight layers, the UE may, for example, indicate that it supports all possible values of a number of layer (from one through eight) for an UL transmission. Alternatively, the UE may indicate that it supports some subset of the values one through eight for a number of layers for an UL transmission (e.g., that it supports values of one, two, three, four, six, or eight layer UL transmissions).

For a UE supporting eight Tx UL transmission, a base station may configure to the UE an antenna configuration (or the corresponding codebook) that the UE is to use. The base station may configure the UE with eight Tx UL and a corresponding antenna configuration (or a corresponding codebook), subject to UE capability (e.g., as previously indicated to the base station by the UE).

In some cases where the UE is capable of eight Tx UL, the base station may configure the UE with two or four Tx UL, in which case the UE uses only some of its antennas for transmission. In some of these cases, the base station may further indicate which subset(s) of antennas are used. Alternatively, the selection of the subset(s) of antennas to use may be according to a UE implementation/selection.

For a UE supporting eight Tx UL, the UE may request to use only two or four Tx UL under certain circumstances, e.g., when certain antennas are blocked, or when the UE would like to use fewer than eight antennas in order to save power.

Embodiments for codebooks for fully-coherent, partially-coherent and/or non-coherent antenna configurations are now discussed.

In a first case, a large codebook including precoding matrices (precoders) for all types of antenna configurations (fully-coherent, partially-coherent and non-coherent) may be defined, and a UE capable of 8 Tx UL with fully-coherent antenna usage can be indicated with one of the entries in the codebook.

In a second case, separate fully-coherent, partially-coherent and non-coherent codebooks may be defined for each of the fully-coherent, partially-coherent and non-coherent antenna configuration cases. A base station may then configure which set(s) of these codebooks to use at a UE for eight Tx UL depending on the UE's reported/supported antenna configuration(s) or codebook(s).

For a UE configured with eight Tx UL, a base station may further configure a maximum number of layers (or maximum rank) to be used for an UL transmission (which may in at least some cases be subject to a UE capability as previously signaled to the base station by the UE).

Additionally/alternatively, for a UE configured with eight Tx UL, a base station may configure a set of rank values that may be used for an UL transmission (which may in at least some cases be subject to a UE capability as previously signaled to the base station by the UE). For example, the base station may configure to the UE that only ranks one, two, four, six or eight are to be used. This may help in reducing DCI overhead.

In some embodiments, codebook(s) to use for a particular UE capability may be pre-defined (e.g., in specification(s) for the wireless communication system).

In a first such example, it may be that a UE uses a codebook corresponding to its antenna configuration. For example, a fully-coherent UE uses a fully-coherent codebook that is for the case of fully-coherent antennas, a partially-coherent UE uses a partially-coherent codebook for the case of partially-coherent antennas, and a non-coherent UE uses a non-coherent codebook for non-coherent antenna configurations.

In a second example, UE may use a codebook(s) defined for type(s) of antenna configuration other than its own. For example, a fully-coherent UE may use the fully-coherent, partially-coherent and non-coherent codebooks corresponding to fully-coherent, partially-coherent and non-coherent antenna configurations, and a partially-coherent UE may use the partially-coherent and non-coherent codebooks corresponding to partially-coherent and non-coherent antenna configurations. In some cases, it may be desirable to allow the use of partially-coherent or non-coherent codebooks even for fully-coherent UEs. For example, it may be that signals from one or more APs may be blocked or severely attenuated, in which case it may be better to use the APs with stronger signals instead of all the APs (as in fully-coherent codebooks).

Alternatively or additionally to such cases where codebook(s) are predefined for particular UE capabilities, a base station may instead provide configurations for codebook restriction to indicate which precoding matrices may be used. The domain for a rank indicator (RI)/PMI information field combination in DCI would in such cases need to cover only the allowed precoding matrices under such a codebook restriction, so the DCI overhead may be reduced under such cases.

In a first example for a codebook restriction, a bitmap may be provided to the UE, with each bit corresponding to each defined precoding matrix and whether that precoding matrix is usable (or not).

In a second example for a codebook restriction, either in the case of a large codebook that is defined to cover all antenna configurations or in the case of separately defined fully-coherent, partially-coherent and non-coherent codebooks for fully-coherent, partially-coherent and non-coherent antenna configurations, the base station may provide additional signaling to the UE to indicate, on an antenna configuration basis, whether the precoding matrices for fully-coherent, partially-coherent, and/or non-coherent antenna configurations are useable (using, for example, 3 bits corresponding to these antenna configurations).

### Codebook and the RI/PMI Indication in DCI

For a codebook-based transmission scheme for a fully-coherent antenna configuration, a codebook design may be based on a DL eight Tx Type-1 single-panel codebook design. Such a design may be based on codebook mode 1 of DL 8 Tx Type-1 single-panel codebook design. Note that in at least some embodiments, codebook mode 2 may not be necessary in the case that sub-band beam selection is not supported for UL.

In some embodiments, a fixed mapping may be defined between APs and polarization, which carries impacts to the structure of the precoder matrix. For example, APs 0/2/4/6 may correspond to one polarization, while APs 1/3/5/7 correspond to the other polarization. Alternatively, APs 0/1/2/3 may correspond to one polarization, while APs 4/5/6/7 correspond to the other polarization.

In some embodiments, with respect to channel sounding that is performed by the UE, a single SRS resource set may be configured with a usage set to ‘codebook.’ This SRS resource set may include one SRS resource consisting of eight SRS ports, or it may include two SRS resources each consisting of four SRS ports. In various embodiments, it may be that there is ultimately is no need for an SRI field in the DCI that schedules the UL transmission, because all eight ports for an SRS resource set/the SRS resource(s) of the SRS resource set may be used for UL channel sounding.

Then (e.g., after channel sounding), a DCI that schedules an UL transmission may be transmitted from the network to the UE. The DCI may include a “precoding information and number of layers field” that indicates rank information and precoder information for the UL transmission. There are various options for arranging such information in the precoding information and number of layers field.

In a first option, a precoding information and number of layers field may include separate RI and PMI information (e.g., a TPMI index) (or alternatively, it may be replaced by separate RI and PMI information fields) in case of 8 Tx UL. In such circumstances, a bit width of the RI information is given by ┌log₂(n_{RI})┐, where n_{RI} is the number of rank values that may be used. For example, if ranks one to eight are each useable, there are eight possible ranks and the bit width of the RI is three. If only ranks {two, four, six, eight} are usable (e.g., as configured by the network), then there are four possible ranks and the bit width of the RI is two.

Further, in such cases, it may be that the PMI information indicates a TPMI index. This TPMI index may be understood to correspond to the rank indicated by the RI information (in other words, it may be that same values for TPMI indexes may ultimately be interpreted differently for different provided rank values). Accordingly, the actual number of bits for a TPMI index that is needed with respect to each rank may be different, meaning that, for purposes of DCI decoding, the bit width of the PMI information in such cases may need to be known ahead of time at the UE. The bit width of the PMI information can be defined based on the max number of bits needed for a TPMI index among all the allowed rank values. Within this construct, padding may be added to a TPMI index in cases where there is a fewer number of bits is required with respect to a given applicable rank.

The first option may be used in cases when only a fully-coherent codebook is used, or in cases where separate bit(s) are used in DCI that indicate to the UE that a fully-coherent codebook can be used. As an example, in the case where separate bit(s) are used, and where the bits indicate that both partially-coherent and fully-coherent codebooks can be used, there may be an individual bit in the DCI that indicates that the fully-coherent codebook is used. In such cases, RI information and PMI information as described may indicate which rank/precoder is to be used.

In a second option, a precoding information and number of layers field indicates a rank and precoding matrix jointly (or the rank can be considered as embedded in the precoding matrix), by building a combined precoding matrix table/codebook used for all the allowed rank values. In such cases, each precoding matrix in this codebook is associated with a TPMI index. Accordingly, the bit width of the precoding information and number of layers field is thus determined with respect to the total number of precoding matrices in the combined table.

This second option may be applicable when a large codebook that includes precoding matrices for all antenna configurations (fully-coherent, partially-coherent and non-coherent) is defined, as has been discussed. In such cases, the precoder matrices discussed here for fully-coherent antenna configurations may be only part of the large codebook.

This second option may (also) be applicable when fully-coherent, partially-coherent and non-coherent codebooks are defined separately for fully-coherent, partially-coherent and non-coherent antenna configurations, as has been discussed.

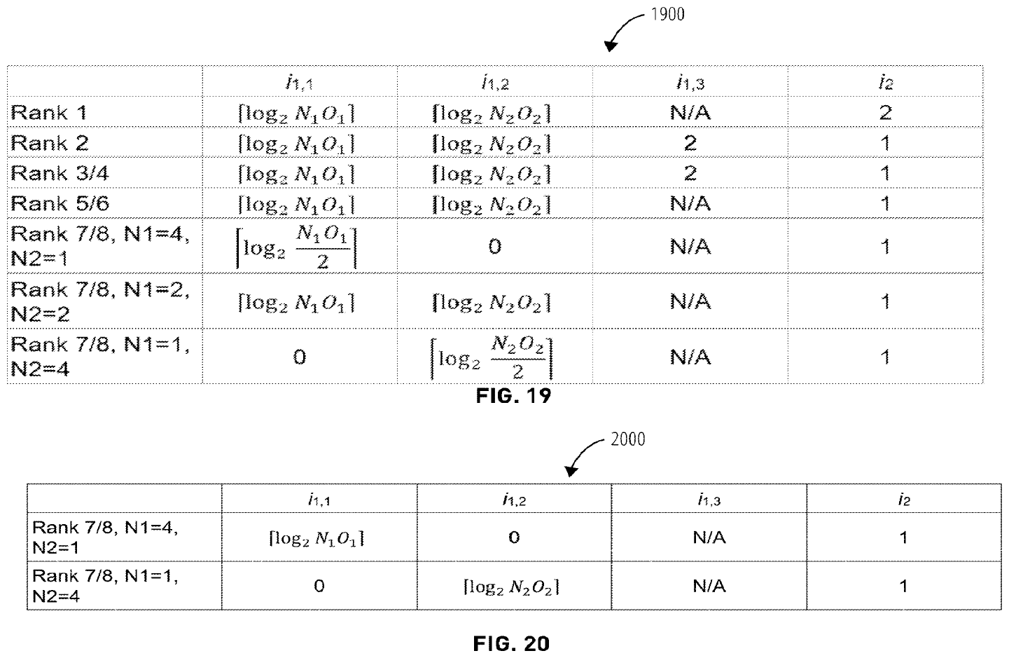

FIG. 19 illustrates a table 1900 showing the number of bits used for PMI information for each rank value in the case where a codebook mode 1 of DL eight Tx Type-1 single-panel codebook design is directly reused (and with the same oversampling factor rules used).

For the first option previously discussed, where PMI information is separately indicated from a RI in a precoding information and number of layers field (including cases where the precoding information and number of layers field is replaced by separate RI and PMI information fields), the bit width of the PMI information field is determined by the rank which ultimately results in the largest possible codebook for the applicable antenna layout (and thus uses the largest number of bits to cover the domain for TPMI indexes into that codebook). In the table 1900, this is rank 2.

Taking the rank 2 row of the table 1900, in cases using an antenna layout of N₁=4 and N₂=1 (or N₁=1 and N₂=4), and where an oversampling factor rule used is Oᵢ=4 if Nᵢ>1, Oᵢ=1 if Nᵢ=1, the number of bits needed to cover the domain for TPMI indexes for a codebook for rank 2 may be calculated as 4+2+1=7 bits.

Further, for cases using an antenna layout of N₁=N₂=2, and where an oversampling factor rule used is Oᵢ=4 if Nᵢ>1, Oᵢ=1 if Nᵢ=1, the number of bits needed to cover the domain for TPMI indexes for a codebook for rank 2 is 3+3+2+1=9 bits.

Then, for these cases, assuming that the RI of the precoding information and number of layers field uses 3 bits (to cover the domain across ranks 1 to 8), the overall precoding information and number of layers field uses a total of 10 or 12 bits (depending on the applicable antenna layout). This is in comparison to six bits needed for a precoding information and number of layers field (that represents a joint RI and PMI indication) in some four Tx cases.

For the second option previously discussed, where a precoding information and number of layers field indicates rank and precoding matrix jointly (or where rank is considered as embedded in the precoding matrix) and in the case where fully-coherent, partially-coherent and non-coherent codebooks are defined separately for fully-coherent, partially-coherent and non-coherent antenna configurations, for the N₁=4 and N₂=1 antenna layout (or for the N₁=1 and N₂=4 antenna layout), the total number of precoding matrices is 64 for rank one+128 for rank two+128 for rank three+128 for rank four+32 for rank five+32 for rank six+16 for rank seven+16 for rank eight=544 total precoder matrices, which can be represented using 10 bits.

Further, for the N₁=N₂=2 antenna layout, the total number of precoding matrices is 256 for rank one+512 for rank two+512 for rank three+512 for rank four+128 for rank five+128 for rank six+128 for rank seven+128 for rank eight=2304 total precoder matrices, which can be representationally covered using 12 bits.

A comparison of the use under the first and second options accordingly shows that the DCI overhead in number of bits is the same in the present examples. Note that it may be considered that the first option is ultimately considered more straightforward (due to the use of separate RI and PMI information in the precoding information and number of layers field).

Various options with respect to the overall framework that was described in relation to FIG. 19 are now discussed.

A first set of options relates to the selection and use of the oversampling factors O₁ and O₂. In a first alternative for such options, it may be assumed that a same oversampling factor of four as may be applied in some DL cases is used (e.g., an oversampling factor rule where Oᵢ=4 if Nᵢ>1 and Oᵢ=1 if Nᵢ=1, where i=1 or 2, is used). This first alternative was used in the formal discussion of FIG. 19.

In a second alternative for the first set of options, it may be an oversampling factor of 2 is used. In such cases the oversampling rule used may be that Oᵢ=2 if Nᵢ>1, and Oᵢ=1 if Nᵢ=1, where i=1 or 2. The reduction of the maximum Oᵢ from four as under the first alternative to two under this second alternative ultimately reduces the maximum number of bits needed for the precoding information and number of layers field in DCI.

In a third alternative for the first set of options, no oversampling is used (e.g., O₁=O₂=1). This limit on Oᵢ of one ultimately reduces the maximum number of bits needed for the precoding information and number of layers field in the DCI.

Note that for the O₁=O₂=1 case, because there is no oversampling, the beam selection scheme for ranks seven and/or eight for N₁=1 or N₂=1 may be modified to where the beam may be selected from one of N₁ or N₂ beams. FIG. 20 illustrates a table 2000 showing a corresponding bit width for these ranks and antenna layout conditions for cases where there is no oversampling and O₁=O₂=1.

In a fourth alternative for the first set of options, other oversampling factors may be chosen for O₁ and O₂. For example, it may be that O₁=2 and O₂=4. The selections of Oᵢ may be chosen to ultimately reduce the maximum number of bits needed for the precoding information and number of layers field in the DCI as opposed to other possible cases.

In some embodiments, it may be that the network is capable of selecting between some or all of this first set options for the selection and use of the oversampling factors O₁ and O₂.

Comparisons in PMI information overhead as between these alternatives for the first set of options are now discussed. Assuming the first option where PMI information is separately indicated from an RI in a precoding information and number of layers field (including cases where the precoding information and number of layers field is replaced by separate RI and PMI information fields):
Under the first alternative, the TPMI index in PMI information uses seven bits in the case that either N₁=1 or N₂=1 and uses nine bits in the case that N₁=N₂=2;
Under the second alternative, TPMI index in PMI information uses six bits in the case that either N₁=1 or N₂=1 and uses seven bits in the case that N₁=N₂=2; and
Under the third alternative, TPMI index in PMI information uses five bits in either of the case that either N₁=1 or N₂=1 or in the case that N₁=N₂=2.

Note that the cost of achieving reduced DCI overhead as described with respect to this first set of options is that there is a lower granularity available for beam selection, which may lead to a comparative degradation in performance in some circumstances.

A second set of options under the framework described in FIG. 19 relates to reducing the choices for i_{1,3}. It may be that ranks two, three, and four use an i_{1,3} indication that indicates a second beam in the form of beam index offsets to the first beam. To reduce overhead it may be that i_{1,3} is be reduced to one bit or zero bits.

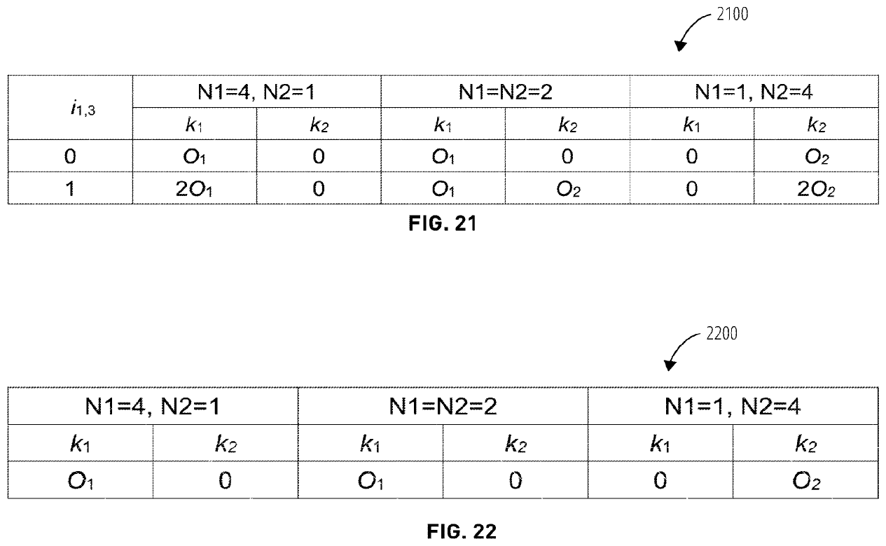

A first example of reducing the choices for i_{1,3} relates to a one bit i_{1,3}. This case corresponds to the reduction of a precoding information and number of layers field by one bit. FIG. 21 illustrates a table 2100 showing calculations for beam index offset values k₁ and k₂ for various antenna layouts in cases where a one bit i_{1,3} may be used.

A second example of reducing the choices for i_{1,3} relates to a zero bit i_{1,3} (meaning that the offset is pre-defined). This case corresponds to the reduction of a precoding information and number of layers field by two bits. FIG. 22 illustrates a table 2200 showing pre-defined beam index offset values k₁ and k₂ for various antenna layouts in cases where a zero bit i_{1,3} may be used.

Note that the table 2100 of FIG. 21 and the table 2200 of FIG. 22 are given by way of example and not by way of limitation. Other values/formulas for determining beam index offset values k₁ and k₂ may be used in other embodiments.

In cases where PMI information is separately indicated from RI in a precoding information and number of layers field (including cases where the precoding information and number of layers field is replaced by separate RI and PMI information fields), a bit width of the PMI information field (TPMI index) is determined/controlled by the rank with using the largest number of bits to cover the codebook entries for that rank. Accordingly, there may be one or more ranks that use fewer than this largest number of bits to cover the codebook entries for that rank, meaning that the granularity of a TPMI index in the PMI information field may not be fully leveraged with respect to such ranks. To minimize this waste, a TPMI index granularity may be increased for such entries with the goal of further utilizing all available bits.

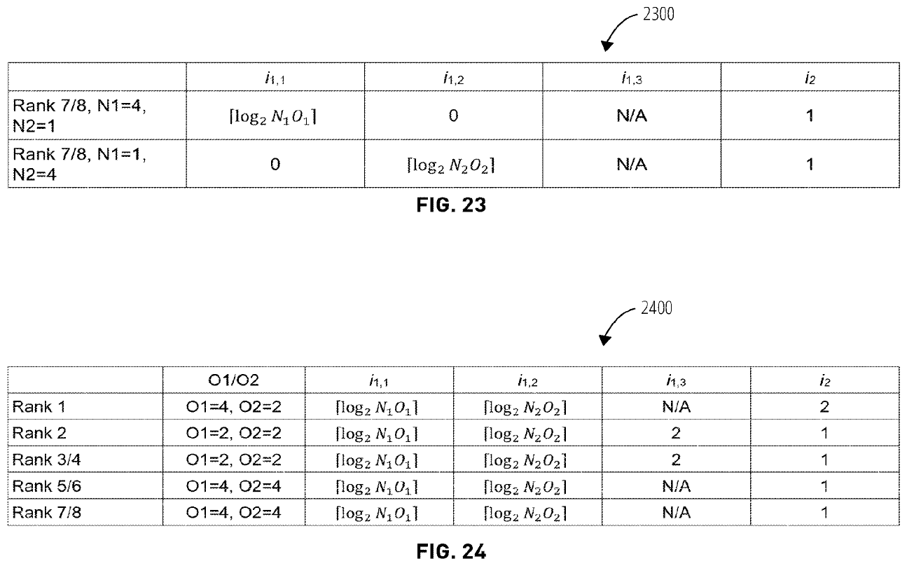

Accordingly, a third set of options under the framework described in FIG. 19 relates to the modification of the use of the TPMI index for ranks seven and/or eight. In such cases, for N₁=4 and N₂=1 (or for N₁=1 and N₂=4) a beam is selected from one of the N₁*O₁ or N₂*O₂ oversampling beams. FIG. 23 illustrates a table 2300 showing a corresponding bit width for cases where a TPMI index for rank seven and/or eight is modified for increased granularity.

A fourth set of options under the framework described in FIG. 19 relates to a selection of different oversampling factors for different rank values to further align a number of bits used for each of the different rank values. FIG. 24 illustrates a table 2400 showing a corresponding bit width for cases where different oversampling factors for different rank values are selected. For example, for N₁=N₂=2, the O₁ and O₂ values illustrated in the table 2400 can be used. Even though the number of bits for different rank values are still not completely aligned in this case, the bits are more efficiently used under these circumstances.

Note that for each antenna layout, multiple such tables in the vein of the table 2400 may be defined, and a base station may configure for one of them.

It is contemplated that two or more of the first through the fourth set of options under the framework described in FIG. 19 can be used in combination. This may be done to more fully align the number of bits in the TPMI index in a PMI information field in cases where the PMI information (TPMI index) is separately indicated from RI (including cases where the precoding information and number of layers field is replaced by separate RI and PMI information fields).

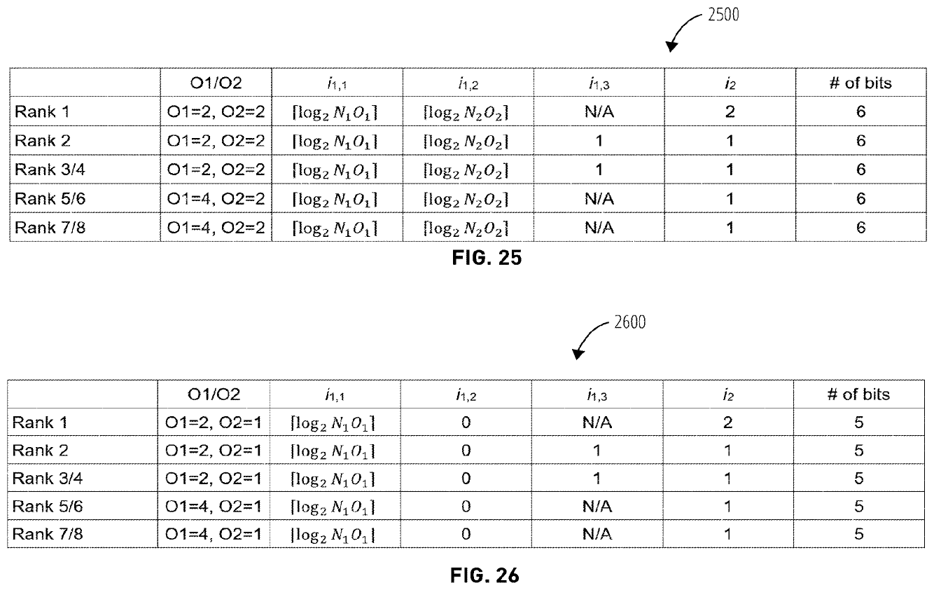

For example, FIG. 25 illustrates a table 2500 that may be defined, where the table 2500 shows a corresponding bit width in the case where N₁=N₂=2.

As another example, FIG. 26 illustrates a table 2600 that may be defined, where the table 2600 shows a corresponding bit width in the case where N₁=4 and N₂=1.

In both examples corresponding to the table 2500 of FIG. 25 and the table 2600 of FIG. 26, the number of bits is the same for all the rank values, meaning that the TPMI index in the PMI information field is fully utilized with respect to each rank.

Note that for each antenna layout, multiple such tables in the vein of the table 2400 may be defined, and a base station may configure for one of them.

Some embodiments may be directed towards reducing the total number of precoding matrices across all ranks without significantly impacting performance.

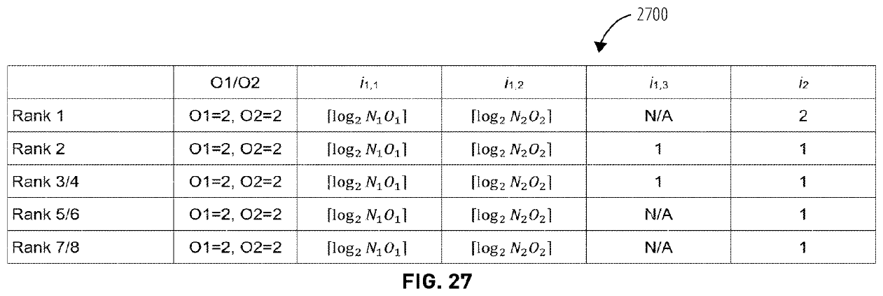

FIG. 27 illustrates a table 2700 that may be defined, where the table 2700 shows a corresponding bit width in the case where N₁=N₂=2. In this case, the total number of precoding matrices is 64 for rank one+64 for rank two+64 for rank three+64 for rank four+32 for rank five+32 for rank six+32 for rank seven+32 for rank eight=for a total of 384 precoding matrices, which can be represented using 9 bits.

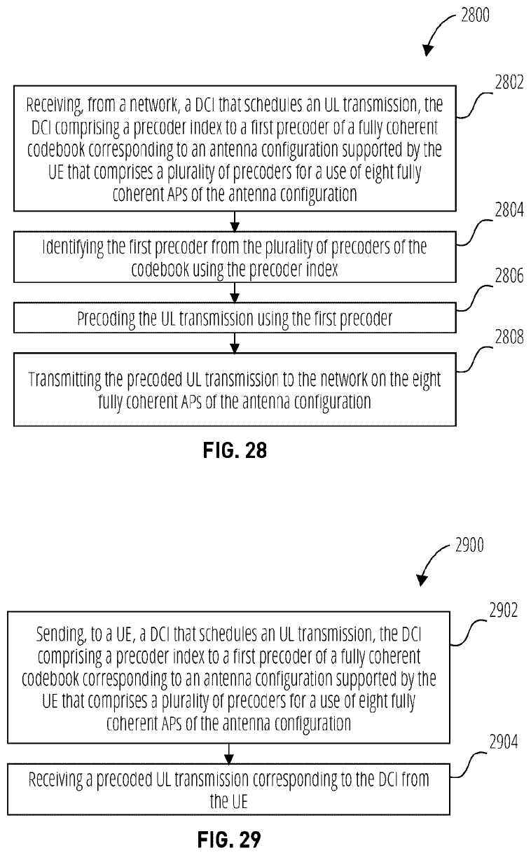

FIG. 28 illustrates a method 2800 of a UE, according to embodiments discussed herein. The method 2800 includes receiving 2802, from a network, a DCI that schedules an UL transmission, the DCI comprising a precoder index to a first precoder of a fully-coherent codebook corresponding to an antenna configuration supported by the UE that comprises a plurality of precoders for a use of eight fully-coherent APs of the antenna configuration. The method 2800 further includes identifying 2804 the first precoder from the plurality of precoders of the codebook using the precoder index. The method 2800 further includes precoding 2806 the UL transmission using the first precoder. The method 2800 further includes transmitting 2808 the precoded UL transmission to the network on the eight fully-coherent APs of the antenna configuration.

In some embodiments, the method 2800 further includes sending, to the network, an indication that the UE supports a use of the fully-coherent codebook corresponding to the antenna configuration with the eight fully-coherent APs; and receiving, from the network, a configuration to use the fully-coherent codebook corresponding to the antenna configuration.

In some embodiments. the method 2800 further includes sending, to the network, an indication of a maximum rank supported by the UE for the UL transmission, and wherein the first precoder uses a precoder rank that is less than or equal to the maximum rank supported by the UE for the UL transmission.

In some embodiments, the method 2800 further includes sending, to the network, an indication of one or more ranks supported by the UE for the UL transmission, and wherein the first precoder uses a precoder rank that is equal to one of the one or more ranks supported by the UE for the UL transmission.

In some embodiments, the method 2800 further includes receiving, from the network, an instruction to use the fully-coherent codebook corresponding to the antenna configuration.

In some embodiments, the method 2800 further includes receiving, from the network, a bitmap indicating a subset of the plurality of precoders of the fully-coherent codebook with which the precoder index is used to identify the first precoder.

In some embodiments of the method 2800, the plurality of precoders of the fully-coherent codebook are non-oversampled precoders.

FIG. 29 illustrates method 2900 of a RAN, according to embodiments discussed herein. The method 2900 includes sending 2902, to a UE, a DCI that schedules an UL transmission, the DCI comprising a precoder index to a first precoder of a fully-coherent codebook corresponding to an antenna configuration supported by the UE that comprises a plurality of precoders for a use of eight fully-coherent APs of the antenna configuration. The method 2900 further includes receiving 2904 a precoded UL transmission corresponding to the DCI from the UE.

In some embodiments, the method 2900 further includes receiving, from the UE, an indication that the UE supports a use of fully-coherent codebooks with the eight fully-coherent APs; and sending, to the UE, a configuration to use the fully-coherent codebook corresponding to the antenna configuration.

In some embodiments, the method 2900 further includes receiving, from the UE, an indication of a maximum rank supported by the UE for the UL transmission, and wherein the first precoder uses a precoder rank that is less than or equal to the maximum rank supported by the UE for the UL transmission.

In some embodiments, the method 2900 further includes receiving, from the UE, an indication of one or more ranks supported by the UE for the UL transmission, and wherein the first precoder uses a precoder rank that is equal to one of the one or more ranks supported by the UE for the UL transmission.

In some embodiments, the method 2900 further includes sending, to the UE, an instruction to use the fully-coherent codebook corresponding to the antenna configuration.

In some embodiments, the method 2900 further includes sending, to the UE, a bitmap indicating a subset of the plurality of precoders of the fully-coherent codebook with which the precoder index is used to identify the first precoder.

In some embodiments of the method 2900, the plurality of precoders of the fully-coherent codebook are non-oversampled precoders.

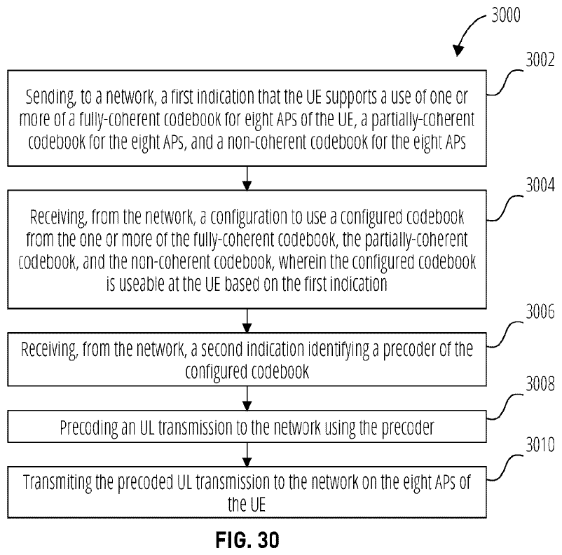

FIG. 30 illustrates a method 3000 of a UE, according to embodiments discussed herein. The method 3000 includes sending 3002, to a network, a first indication that the UE supports a use of one or more of a fully-coherent codebook for eight APs of the UE, a partially-coherent codebook for the eight APs, and a non-coherent codebook for the eight APs. The method 3000 further includes receiving 3004, from the network, a configuration to use a configured codebook from the one or more of the fully-coherent codebook, the partially-coherent codebook, and the non-coherent codebook, wherein the configured codebook is useable at the UE based on the first indication. The method 3000 further includes receiving 3006, from the network, a second indication identifying a precoder of the configured codebook. The method 3000 further includes precoding 3008 an UL transmission to the network using the precoder. The method 3000 further includes transmitting 3010 the precoded UL transmission to the network on the eight APs of the UE.

In some embodiments of the method 3000, the first indication indicates that the UE supports the use of the fully-coherent codebook, and the configured codebook is the fully-coherent codebook.

In some embodiments of the method 3000, the first indication indicates that the UE supports the use of the fully-coherent codebook (which may imply the UE also supports the use of the partially-coherent codebook), and the configured codebook is the partially-coherent codebook.

In some embodiments of the method 3000, the first indication indicates that the UE supports the use of the fully-coherent codebook (which may imply the UE also supports the use of the non-coherent codebook), and the configured codebook is the non-coherent codebook.

In some embodiments of the method 3000, the first indication indicates that the UE supports the use of the partially-coherent codebook, and the configured codebook is the partially-coherent codebook.

In some embodiments of the method 3000, the first indication indicates that the UE supports the use of the partially-coherent codebook (which may imply the UE also supports the use of the non-coherent codebook), and the configured codebook is the non-coherent codebook.

In some embodiments of the method 3000, the first indication indicates that the UE supports the use of the non-coherent codebook, and the configured codebook is the non-coherent codebook.

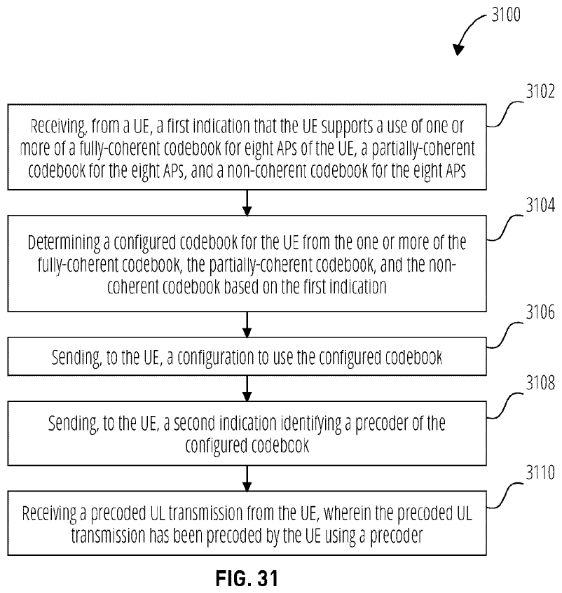

FIG. 31 illustrates a method 3100 of a RAN, according to embodiments discussed herein. The method 3100 includes receiving 3102, from a UE, a first indication that the UE supports a use of one or more of a fully-coherent codebook for eight APs of the UE, a partially-coherent codebook for the eight APs, and a non-coherent codebook for the eight APs. The method 3100 further includes determining 3104 a configured codebook for the UE from the one or more of the fully-coherent codebook, the partially-coherent codebook, and the non-coherent codebook based on the first indication. The method 3100 further includes sending 3106, to the UE, a configuration to use the configured codebook. The method 3100 further includes sending 3108, to the UE, a second indication identifying a precoder of the configured codebook. The method 3100 further includes receiving 3110 a precoded UL transmission from the UE, wherein the precoded UL transmission has been precoded by the UE using the precoder.

In some embodiments of the method 3100, the first indication indicates that the UE supports the use of the fully-coherent codebook, and the configured codebook is the fully-coherent codebook.

In some embodiments of the method 3100, the first indication indicates that the UE supports the use of the fully-coherent codebook (which may imply the UE also supports the use of the partially-coherent codebook), and the configured codebook is the partially-coherent codebook.

In some embodiments of the method 3100, the first indication indicates that the UE supports the use of the fully-coherent codebook (which may imply the UE also supports the use of the non-coherent codebook), and the configured codebook is the non-coherent codebook.

In some embodiments of the method 3100, the first indication indicates that the UE supports the use of the partially-coherent codebook, and the configured codebook is the partially-coherent codebook.

In some embodiments of the method 3100, the first indication indicates that the UE supports the use of the partially-coherent codebook (which may imply the UE also supports the use of the non-coherent codebook), and the configured codebook is the non-coherent codebook.

In some embodiments of the method 3100, the first indication indicates that the UE supports the use of the non-coherent codebook, and the configured codebook is the non-coherent codebook.

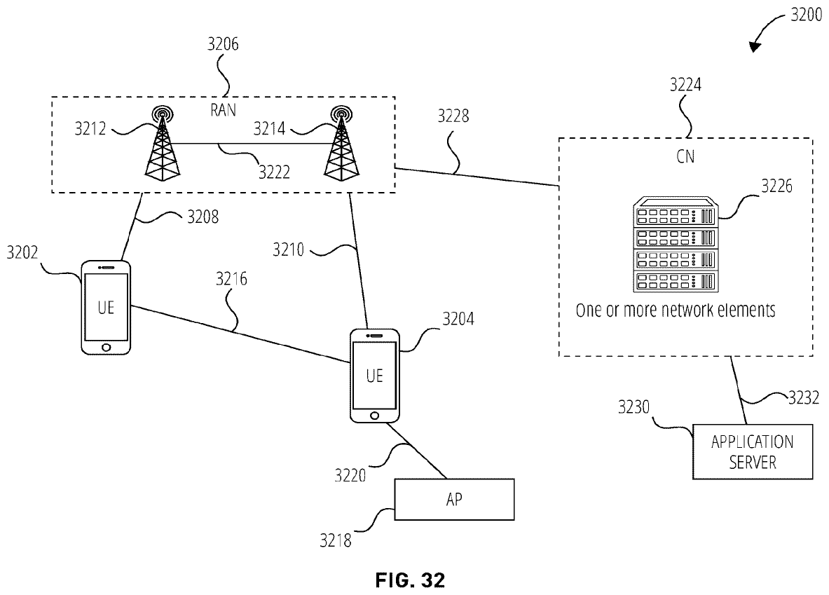

FIG. 32 illustrates an example architecture of a wireless communication system 3200, according to embodiments disclosed herein. The following description is provided for an example wireless communication system 3200 that operates in conjunction with the LTE system standards and/or 5G or NR system standards as provided by 3GPP technical specifications.

As shown by FIG. 32, the wireless communication system 3200 includes UE 3202 and UE 3204 (although any number of UEs may be used). In this example, the UE 3202 and the UE 3204 are illustrated as smartphones (e.g., handheld touchscreen mobile computing devices connectable to one or more cellular networks), but may also comprise any mobile or non-mobile computing device configured for wireless communication.

The UE 3202 and UE 3204 may be configured to communicatively couple with a RAN 3206. In embodiments, the RAN 3206 may be NG-RAN, E-UTRAN, etc. The UE 3202 and UE 3204 utilize connections (or channels) (shown as connection 3208 and connection 3210, respectively) with the RAN 3206, each of which comprises a physical communications interface. The RAN 3206 can include one or more base stations (such as base station 3212 and base station 3214) that enable the connection 3208 and connection 3210.

In this example, the connection 3208 and connection 3210 are air interfaces to enable such communicative coupling, and may be consistent with RAT(s) used by the RAN 3206, such as, for example, an LTE and/or NR.

In some embodiments, the UE 3202 and UE 3204 may also directly exchange communication data via a sidelink interface 3216. The UE 3204 is shown to be configured to access an access point (shown as AP 3218) via connection 3220. By way of example, the connection 3220 can comprise a local wireless connection, such as a connection consistent with any IEEE 802.11 protocol, wherein the AP 3218 may comprise a Wi-Fi® router. In this example, the AP 3218 may be connected to another network (for example, the Internet) without going through a CN 3224.

In embodiments, the UE 3202 and UE 3204 can be configured to communicate using orthogonal frequency division multiplexing (OFDM) communication signals with each other or with the base station 3212 and/or the base station 3214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 3212 or base station 3214 may be implemented as one or more software entities running on server computers as part of a virtual network. In addition, or in other embodiments, the base station 3212 or base station 3214 may be configured to communicate with one another via interface 3222. In embodiments where the wireless communication system 3200 is an LTE system (e.g., when the CN 3224 is an EPC), the interface 3222 may be an X2 interface. The X2 interface may be defined between two or more base stations (e.g., two or more eNBs and the like) that connect to an EPC, and/or between two eNBs connecting to the EPC. In embodiments where the wireless communication system 3200 is an NR system (e.g., when CN 3224 is a 5GC), the interface 3222 may be an Xn interface. The Xn interface is defined between two or more base stations (e.g., two or more gNBs and the like) that connect to 5GC, between a base station 3212 (e.g., a gNB) connecting to 5GC and an eNB, and/or between two eNBs connecting to 5GC (e.g., CN 3224).

The RAN 3206 is shown to be communicatively coupled to the CN 3224. The CN 3224 may comprise one or more network elements 3226, which are configured to offer various data and telecommunications services to customers/subscribers (e.g., users of UE 3202 and UE 3204) who are connected to the CN 3224 via the RAN 3206. The components of the CN 3224 may be implemented in one physical device or separate physical devices including components to read and execute instructions from a machine-readable or computer-readable medium (e.g., a non-transitory machine-readable storage medium).

In embodiments, the CN 3224 may be an EPC, and the RAN 3206 may be connected with the CN 3224 via an S1 interface 3228. In embodiments, the S1 interface 3228 may be split into two parts, an S1 user plane (S1-U) interface, which carries traffic data between the base station 3212 or base station 3214 and a serving gateway (S-GW), and the S1-MME interface, which is a signaling interface between the base station 3212 or base station 3214 and mobility management entities (MMEs).

In embodiments, the CN 3224 may be a 5GC, and the RAN 3206 may be connected with the CN 3224 via an NG interface 3228. In embodiments, the NG interface 3228 may be split into two parts, an NG user plane (NG-U) interface, which carries traffic data between the base station 3212 or base station 3214 and a user plane function (UPF), and the S1 control plane (NG-C) interface, which is a signaling interface between the base station 3212 or base station 3214 and access and mobility management functions (AMFs).

Generally, an application server 3230 may be an element offering applications that use internet protocol (IP) bearer resources with the CN 3224 (e.g., packet switched data services). The application server 3230 can also be configured to support one or more communication services (e.g., VoIP sessions, group communication sessions, etc.) for the UE 3202 and UE 3204 via the CN 3224. The application server 3230 may communicate with the CN 3224 through an IP communications interface 3232.

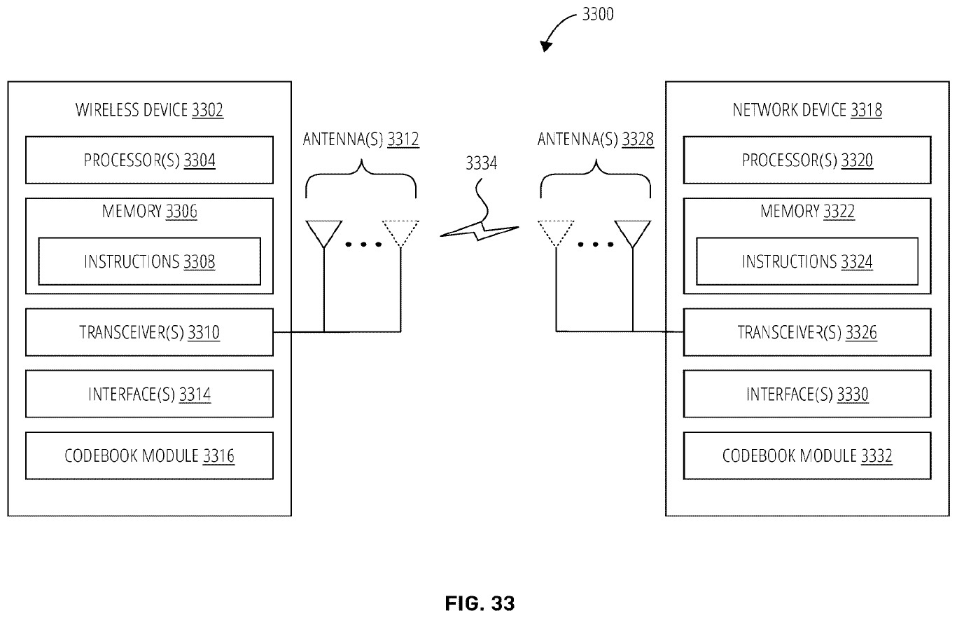

FIG. 33 illustrates a system 3300 for performing signaling 3334 between a wireless device 3302 and a network device 3318, according to embodiments disclosed herein. The system 3300 may be a portion of a wireless communications system as herein described. The wireless device 3302 may be, for example, a UE of a wireless communication system. The network device 3318 may be, for example, a base station (e.g., an eNB or a gNB) of a wireless communication system.

The wireless device 3302 may include one or more processor(s) 3304. The processor(s) 3304 may execute instructions such that various operations of the wireless device 3302 are performed, as described herein. The processor(s) 3304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 3302 may include a memory 3306. The memory 3306 may be a non-transitory computer-readable storage medium that stores instructions 3308 (which may include, for example, the instructions being executed by the processor(s) 3304). The instructions 3308 may also be referred to as program code or a computer program. The memory 3306 may also store data used by, and results computed by, the processor(s) 3304.

The wireless device 3302 may include one or more transceiver(s) 3310 that may include radio frequency (RF) transmitter and/or receiver circuitry that use the antenna(s) 3312 of the wireless device 3302 to facilitate signaling (e.g., the signaling 3334) to and/or from the wireless device 3302 with other devices (e.g., the network device 3318) according to corresponding RATs.

The wireless device 3302 may include one or more antenna(s) 3312 (e.g., one, two, four, or more). For embodiments with multiple antenna(s) 3312, the wireless device 3302 may leverage the spatial diversity of such multiple antenna(s) 3312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 3302 may be accomplished according to precoding (or digital beamforming) that is applied at the wireless device 3302 that multiplexes the data streams across the antenna(s) 3312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 3302 may implement analog beamforming techniques, whereby phases of the signals sent by the antenna(s) 3312 are relatively adjusted such that the (joint) transmission of the antenna(s) 3312 can be directed (this is sometimes referred to as beam steering).

The wireless device 3302 may include one or more interface(s) 3314. The interface(s) 3314 may be used to provide input to or output from the wireless device 3302. For example, a wireless device 3302 that is a UE may include interface(s) 3314 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 3310/antenna(s) 3312 already described) that allow for communication between the UE and other devices and may operate according to known protocols (e.g., Wi-Fi®, Bluetooth®, and the like).

The wireless device 3302 may include a codebook module 3316. The codebook module 3316 may be implemented via hardware, software, or combinations thereof. For example, the codebook module 3316 may be implemented as a processor, circuit, and/or instructions 3308 stored in the memory 3306 and executed by the processor(s) 3304. In some examples, the codebook module 3316 may be integrated within the processor(s) 3304 and/or the transceiver(s) 3310. For example, the codebook module 3316 may be implemented by a combination of software components (e.g., executed by a DSP or a general processor) and hardware components (e.g., logic gates and circuitry) within the processor(s) 3304 or the transceiver(s) 3310.

The codebook module 3316 may be used for various aspects of the present disclosure, for example, aspects of FIG. 1 through FIG. 27. The codebook module 3316 may be configured to, for example, cause the wireless device 3302 to operate using codebook features that have been described herein. For example, in some cases, the codebook module 3316 may configure the wireless device 3302 to receive a DCI that schedules an UL transmission, the DCI comprising a precoder index to a first precoder of a fully-coherent codebook corresponding to an antenna configuration supported by the UE that comprises a plurality of precoders for a use of eight fully-coherent APs of the antenna configuration; identify the first precoder from the plurality of precoders of the codebook using the precoder index; precode the UL transmission using the first precoder; and transmitting the precoded UL transmission on the eight fully-coherent APs of the antenna configuration.

The network device 3318 may include one or more processor(s) 3320. The processor(s) 3320 may execute instructions such that various operations of the network device 3318 are performed, as described herein. The processor(s) 3320 may include one or more baseband processors implemented using, for example, a CPU, a DSP, an ASIC, a controller, an FPGA device, another hardware device, a firmware device, or any combination thereof configured to perform the operations described herein.

The network device 3318 may include a memory 3322. The memory 3322 may be a non-transitory computer-readable storage medium that stores instructions 3324 (which may include, for example, the instructions being executed by the processor(s) 3320). The instructions 3324 may also be referred to as program code or a computer program. The memory 3322 may also store data used by, and results computed by, the processor(s) 3320.

The network device 3318 may include one or more transceiver(s) 3326 that may include RF transmitter and/or receiver circuitry that use the antenna(s) 3328 of the network device 3318 to facilitate signaling (e.g., the signaling 3334) to and/or from the network device 3318 with other devices (e.g., the wireless device 3302) according to corresponding RATS.

The network device 3318 may include one or more antenna(s) 3328 (e.g., one, two, four, or more). In embodiments having multiple antenna(s) 3328, the network device 3318 may perform MIMO, digital beamforming, analog beamforming, beam steering, etc., as has been described.

The network device 3318 may include one or more interface(s) 3330. The interface(s) 3330 may be used to provide input to or output from the network device 3318. For example, a network device 3318 that is a base station may include interface(s) 3330 made up of transmitters, receivers, and other circuitry (e.g., other than the transceiver(s) 3326/antenna(s) 3328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 3318 may include a codebook module 3332. The codebook module 3332 may be implemented via hardware, software, or combinations thereof. For example, the codebook module 3332 may be implemented as a processor, circuit, and/or instructions 3324 stored in the memory 3322 and executed by the processor(s) 3320. In some examples, the 3132 may be integrated within the processor(s) 3320 and/or the transceiver(s) 3326. For example, the 3132 may be implemented by a combination of software components (e.g., executed by a DSP or a general processor) and hardware components (e.g., logic gates and circuitry) within the processor(s) 3320 or the transceiver(s) 3326.

The codebook module 3332 may be used for various aspects of the present disclosure, for example, aspects of FIG. 1 through FIG. 27. The codebook module 3332 may be configured to, for example, cause the network device 3318 to operate using codebook features that have been described herein. For example, the codebook module 3332 may configure the network device 3318 to send a DCI that schedules an UL transmission, the DCI comprising a precoder index to a first precoder of a fully-coherent codebook corresponding to an antenna configuration supported by the UE that comprises a plurality of precoders for a use of eight fully-coherent APs of the antenna configuration; and receive a precoded UL transmission corresponding to the DCI.

Embodiments contemplated herein include an apparatus comprising means to perform one or more elements of any of the method 2800 and/or the method 3000. This apparatus may be, for example, an apparatus of a UE (such as a wireless device 3302 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 2800 and/or the method 3000. This non-transitory computer-readable media may be, for example, a memory of a UE (such as a memory 3306 of a wireless device 3302 that is a UE, as described herein).

Embodiments contemplated herein include an apparatus comprising logic, modules, or circuitry to perform one or more elements of any of the method 2800 and/or the method 3000. This apparatus may be, for example, an apparatus of a UE (such as a wireless device 3302 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 2800 and/or the method 3000. This apparatus may be, for example, an apparatus of a UE (such as a wireless device 3302 that is a UE, as described herein).

Embodiments contemplated herein include a signal as described in or related to one or more elements of any of the method 2800 and/or the method 3000.

Embodiments contemplated herein include a computer program or computer program product comprising instructions, wherein execution of the program by a processor is to cause the processor to carry out one or more elements of any of the method 2800 and/or the method 3000. The processor may be a processor of a UE (such as a processor(s) 3304 of a wireless device 3302 that is a UE, as described herein). These instructions may be, for example, located in the processor and/or on a memory of the UE (such as a memory 3306 of a wireless device 3302 that is a UE, as described herein).

Embodiments contemplated herein include an apparatus comprising means to perform one or more elements of any of the method 2900 and/or the method 3100. This apparatus may be, for example, an apparatus of a base station (such as a network device 3318 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 2900 and/or the method 3100. This non-transitory computer-readable media may be, for example, a memory of a base station (such as a memory 3322 of a network device 3318 that is a base station, as described herein).

Embodiments contemplated herein include an apparatus comprising logic, modules, or circuitry to perform one or more elements of any of the method 2900 and/or the method 3100. This apparatus may be, for example, an apparatus of a base station (such as a network device 3318 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 2900 and/or the method 3100. This apparatus may be, for example, an apparatus of a base station (such as a network device 3318 that is a base station, as described herein).

Embodiments contemplated herein include a signal as described in or related to one or more elements of any of the method 2900 and/or the method 3100.

Embodiments contemplated herein include a computer program or computer program product comprising instructions, wherein execution of the program by a processing element is to cause the processing element to carry out one or more elements of any of the method 2900 and/or the method 3100. The processor may be a processor of a base station (such as a processor(s) 3320 of a network device 3318 that is a base station, as described herein). These instructions may be, for example, located in the processor and/or on a memory of the base station (such as a memory 3322 of a network device 3318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, a downlink control information (DCI) that schedules an uplink (UL) transmission, the DCI comprising a precoder index to a first precoder of a fully-coherent codebook corresponding to an antenna configuration supported by the UE that comprises a plurality of precoders for a use of eight fully-coherent antenna ports (APs) of the antenna configuration;
identifying the first precoder from the plurality of precoders of the codebook using the precoder index;
precoding the UL transmission using the first precoder; and
transmitting the precoded UL transmission to the network on the eight fully-coherent APs of the antenna configuration.

2. The method of claim 1, further comprising:
sending, to the network, an indication that the UE supports a use of the fully-coherent codebook corresponding to the antenna configuration with the eight fully-coherent APs; and
receiving, from the network, a configuration to use the fully-coherent codebook corresponding to the antenna configuration.

3. The method of claim 1, further comprising sending, to the network, an indication of a maximum rank supported by the UE for the UL transmission, and wherein the first precoder uses a precoder rank that is less than or equal to the maximum rank supported by the UE for the UL transmission.

4. The method of claim 1, further comprising sending, to the network, an indication of one or more ranks supported by the UE for the UL transmission, and wherein the first precoder uses a precoder rank that is equal to one of the one or more ranks supported by the UE for the UL transmission.

5. The method of claim 1, further comprising receiving, from the network, an instruction to use the fully-coherent codebook corresponding to the antenna configuration.

6. The method of claim 1, further comprising receiving, from the network, a bitmap indicating a subset of the plurality of precoders of the fully-coherent codebook with which the precoder index is used to identify the first precoder.

7. The method of claim 1, wherein the plurality of precoders of the fully-coherent codebook are non-oversampled precoders.

8. A method of a radio access network (RAN), comprising:
sending, to a user equipment (UE), a downlink control information (DCI) that schedules an uplink (UL) transmission, the DCI comprising a precoder index to a first precoder of a fully-coherent codebook corresponding to an antenna configuration supported by the UE that comprises a plurality of precoders for a use of eight fully-coherent antenna ports (APs) of the antenna configuration; and
receiving a precoded UL transmission corresponding to the DCI from the UE.

9. The method of claim 8, further comprising:
receiving, from the UE, an indication that the UE supports a use of fully-coherent codebooks with the eight fully-coherent APs; and
sending, to the UE, a configuration to use the fully-coherent codebook corresponding to the antenna configuration.

10. The method of claim 8, further comprising receiving, from the UE, an indication of a maximum rank supported by the UE for the UL transmission, and wherein the first precoder uses a precoder rank that is less than or equal to the maximum rank supported by the UE for the UL transmission.

11. The method of claim 8, further comprising receiving, from the UE, an indication of one or more ranks supported by the UE for the UL transmission, and wherein the first precoder uses a precoder rank that is equal to one of the one or more ranks supported by the UE for the UL transmission.

12. The method of claim 8, further comprising sending, to the UE, an instruction to use the fully-coherent codebook corresponding to the antenna configuration.

13. The method of claim 8, further comprising sending, to the UE, a bitmap indicating a subset of the plurality of precoders of the fully-coherent codebook with which the precoder index is used to identify the first precoder.

14. The method of claim 8, wherein the plurality of precoders of the fully-coherent codebook are non-oversampled precoders.

15. A method of a user equipment (UE), comprising:
sending, to a network, a first indication that the UE supports a use of one or more of a fully-coherent codebook for eight antenna ports (APs) of the UE, a partially-coherent codebook for the eight APs, and a non-coherent codebook for the eight APs;
receiving, from the network, a configuration to use a configured codebook from the one or more of the fully-coherent codebook, the partially-coherent codebook, and the non-coherent codebook, wherein the configured codebook is useable at the UE based on the first indication;
receiving, from the network, a second indication identifying a precoder of the configured codebook;
precoding an uplink (UL) transmission to the network using the precoder; and
transmitting the precoded UL transmission to the network on the eight APs of the UE.

16. The method of claim 15, wherein the first indication indicates that the UE supports the use of the fully-coherent codebook, and wherein the configured codebook is the fully-coherent codebook.

17. The method of claim 15, wherein the first indication indicates that the UE supports the use of the fully-coherent codebook, and wherein the configured codebook is the partially-coherent codebook.

18. The method of claim 15, wherein the first indication indicates that the UE supports the use of the fully-coherent codebook, and wherein the configured codebook is the non-coherent codebook.

19. The method of claim 15, wherein the first indication indicates that the UE supports the use of the partially-coherent codebook, and wherein the configured codebook is the partially-coherent codebook.

20. The method of claim 15, wherein the first indication indicates that the UE supports the use of the partially-coherent codebook, and wherein the configured codebook is the non-coherent codebook.

21-31. (canceled)
